(19) United States
(12) Patent Application Publication
(10) Pub. No.: US 2025/0268246 A1
(43) Pub. Date: Aug. 28, 2025

(54) DEER STAND CLIMBING SYSTEM

(71) Applicants: Greg Pepple, Edgerton, OH (US); Seth Pepple, Marion (IN)

(72) Inventors: Greg Pepple, Edgerton, OH (US); Seth Pepple, Marion (IN)

(21) Appl. No.: 19/062,522

(22) Filed: Feb. 25, 2025

Related U.S. Application Data
(60) Provisional application No. 63/558,932, filed on Feb. 28, 2024.

(51) Int. Cl. A01M 31/02

(52) U.S. Cl. CPC A01M 31/02

(57) ABSTRACT

A hunting platform system including a platform couplable to a tree and a band extending around the tree. The band being connected to both sides of the platform. The platform has a heal hole positioned in the platform to accommodate a heal of a hunter.

### CROSS REFERENCE TO RELATED APPLICATIONS

This is a non-provisional patent application based upon U.S. provisional patent application Ser. No. 63/558,932, entitled “DEER STAND CLIMBING SYSTEM”, filed Feb. 28, 2024.

### BACKGROUND OF THE INVENTION

### 1. Field of the Invention

The present invention relates to a tree climbing system by way of the invention that additionally serves as a platform coupled to the tree for a hunter to supported.

### 2. Description of the Related Art

A tree stand is a platform used by hunters to elevate themselves above the ground, typically attached to a tree. This elevated position provides a better vantage point for spotting deer and other game, and it helps to keep the hunter's scent above the ground, reducing the chance of detection by the animal.

There are several types of hunting stands such as ladder stands, climbing stands, and hang-on stands. Ladder stands have a ladder attached to the platform, making them easy to climb. They are stable making them suitable for long hunting sessions. Ladder stands are typically coupled to a tree using straps. Climbing stands are portable and allow hunters to climb the tree using the stand itself. They are ideal for hunters who need to move to locations frequently, or that can't leave a stand attached for days or weeks. Hang-on stands are lightweight and can be hung on trees using straps or chains. They require separate climbing aids like climbing sticks or steps.

The benefits of using a tree stand include improved visibility, reduced scent detection and safety. Improved visibility results from being elevated, which gives hunters a better view of the surrounding area, making it easier to spot animals as they move on the ground. Reduced scent detection is inherent to being in an elevated position, which helps keep the hunter's scent above the ground, making it less likely for the quarry to detect them. Further, tree stands can provide a safer shooting angle, reducing the risk of stray bullets causing damage.

What is needed in the art, is a climbing hunting platform with features that increase the climbing efficiency, promote comfort and ensure enhanced footing.

### SUMMARY OF THE INVENTION

The present invention provides an improved hunting platform.

The invention in one form is directed to a hunting platform system including a platform couplable to a tree and a band extending around the tree. The band being connected to both sides of the platform. The platform having a heal hole positioned in the platform to accommodate a heal of a hunter.

The invention in another form is directed to a platform couplable to a tree including a band extending around the tree and connected to both sides of the platform; and at least one foot loop coupled to the platform. The at least one foot loop being used by the hunter to lift or lower the system on the tree.

The invention in yet another form is directed to a method of a hunter using a hunting platform system, the method including the steps of positioning, connecting, climbing, inserting, lifting, engaging and repeating. The positioning step including the positioning of a hunting platform against a tree. The connecting step including the connecting of a band to two sides of the platform and extending around the tree. The climbing step including the hunter climbing upon the hunting platform. The inserting step including the inserting of the hunter's feet into at least one foot loop. The lifting step including the lifting of the hunting platform with the hunter's feet while the hunter is otherwise supported. The engaging step including the engaging of the tree with the platform at a new position. The repeating step including the repeating of the lifting and engaging steps until the platform is at a desired height.

Advantageously the present invention provides a climbing stand with a heal hole feature, thereby enhancing the performance of the hunting stand.

### BRIEF DESCRIPTION OF THE DRAWINGS

The above-mentioned and other features and advantages of this invention, and the

manner of attaining them, will become more apparent and the invention will be better understood by reference to the following description of embodiments of the invention taken in conjunction with the accompanying drawings, wherein:

FIG. 1 illustrates, a hunting platform system of the present invention engaged with the trunk of a tree;

FIG. 2 is a top down perspective view of the hunting platform system of FIG. 1;

FIG. 3 illustrates the hunting platform system of FIGS. 1 and 2 in a perspective view from the tree side;

FIG. 4 illustrates an end view of a memory band of the present invention used as a part of the hunting platform system of FIGS. 1-3;

FIG. 5 illustrates a latching system of the present invention that interfaces with the memory band of FIG. 4;

FIG. 6 is a cross-sectional view of the latching system of FIG. 5 and is part of the hunting platform system of the previous Figs.;

FIG. 7 is another view of the hunting platform system of the previous Figs., particularly illustrating the use of a heal hole in the floor of the platform; and

FIG. 8 is a view from beneath the platform showing the deep engagement of the hunter's heal in the heal hole previously illustrated.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

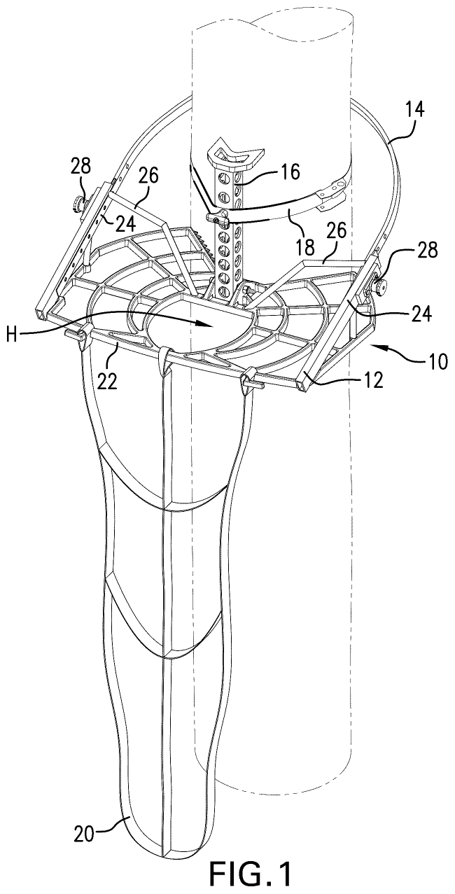

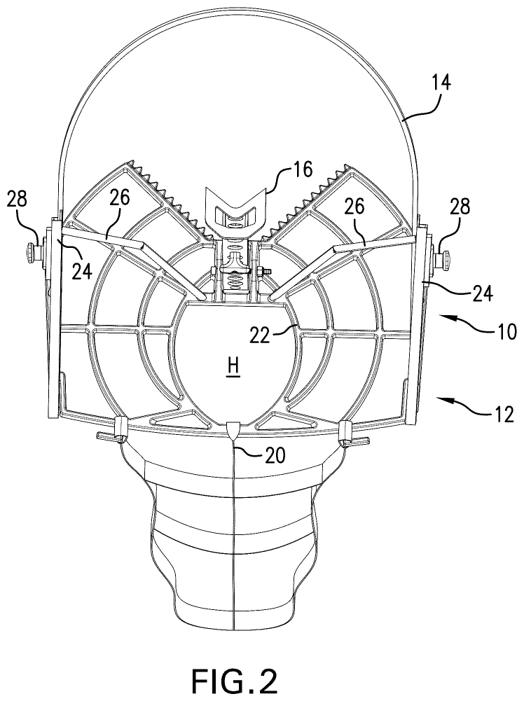

Referring now to the drawings, and more particularly to FIGS. 1 and 2 there is shown a deer stand climbing system 10 having a body 12, a memory band 14, a pivoting arm 16, a pivoting arm strap 18 and a web ladder 20. Body 12 has a platform 22, angled side members 24, foot loops 26, and band latches 28.

Platform 22 as illustrated has an open pattern of structural features that provide rigidity yet light weight. Platform 22 advantageously has a heal hole H that is shaped to accommodate the heal of a hunter to thereby provide a certain and robust control of the hunter's position while using a saddle/sling. Angled side members 24 extend from a front edge of platform 22 at an angle that advantageously allows for the interaction of the back edge of platform 22 that engages the side of the tree and memory band 14 that extends around the back side of the tree so that system 10 will support the weight of the hunter standing on platform 22. Side members 24 have connections on the sides of platform 22 that provide a quasi-triangular rigidity of members 24 to platform 22. When the operator of system 10 had reached a desired height on the tree, the operator pivots pivoting arm 16 upward against the tree, as shown in FIG. 1, and couples strap 18 to secure arm 16 to the tree, thereby preventing system 10 from disengaging from the tree. Pivoting arm 16 serves as a pawl 16 or a dog 16 keeping platform 22 coupled to the tree.

Memory band 14 is a resilient band that has positional memory, so that when band 14 is disengaged on one side by a release of a band latch 28 and band 14 is moved by the operator to go around the tree, the disengaged end of memory band 14 returns to a position proximate to the band latch 28 so that memory band 14 can be easily reengaged with that band latch 28.

The operator can initially position system 10, as illustrated in FIG. 1 a few feet from the ground, with the exception that strap 18 would not be engaged around the tree and pivoting arm 16 would be pivoted downward toward platform 22. The operator can then climb web ladder 20 and stand on platform 22. At this point the operator will affix an end of a sling or swing cord or rope (not shown, but known to hunters) around the tree at an elevated location on the tree. The sling has a portion upon which the operator can sit and which serves to support the operator's weight. The operator then inserts his/her feet into foot loops 26 and lifts system 10 upward along the trunk of the tree, while the operator's weight is supported by the sling. The tops of the operator's feet lift against foot loops 26 to lift system 10 upward. Advantageously, foot loops 26 are ridged to ensure that they can be easily engaged and disengaged by the operator. This ensures that the operator is not unduly coupled to platform 22 and can easily separate therefrom. The operator then steps down on platform 22 causing system 10 to engage with the tree and support his/her weight. The operator then repositions the sling cord to a higher position on the tree and repeats that action to raise system 10 to a higher position on the tree.

Once the operator has reached a desired height then pivoting arm 16 is engaged with the tree and strap 18 is used to secure arm 16 against the tree. The operator then positions the sling cord to provide a preferred comfort and uses platform 22 to position him/herself about the tree as is needed for the intended viewing from the elevated position established on the tree.

When the operator is finished the operation can be reversed to return to ground level, or the operator can disconnect system 10 and rappel down the side of the tree using his/her feet to “walk” down the side of the tree. The sling mechanism, or a rappelling system, which is not part of the present invention, includes devices that disconnect the rope/cord from the tree so that nothing is left connected to the tree and the operator can simply carry the sling and system 10 from the wooded area. System 10 is advantageously coupled to a backpack arrangement for easy transport into and from the wooded area.

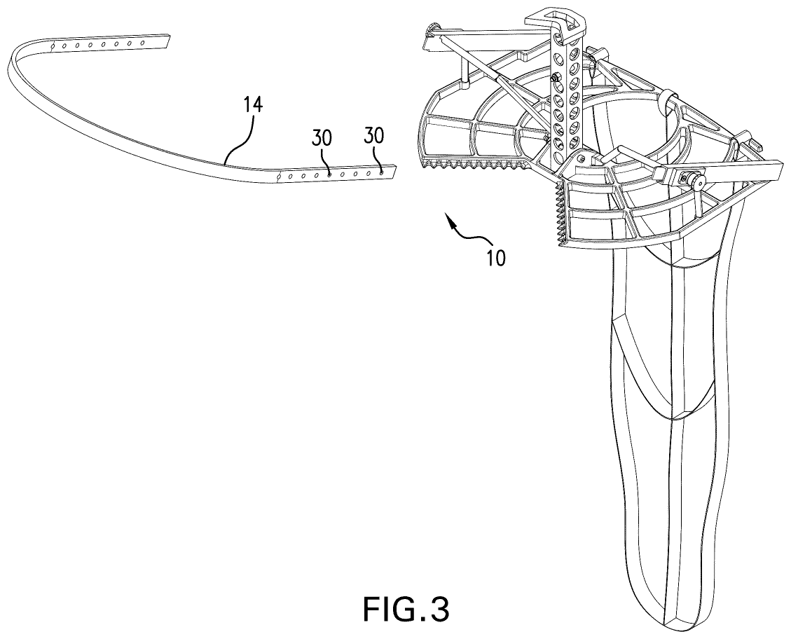

Now, additionally referring to FIG. 3 there is shown another view of band 14 having a series of spaced apart holes 30, which allow band latches 28 to adjust the effective length of band 12 about the tree. It is also contemplated to provide differing lengths of band 12 for differing diameters of trees. It is further contemplated to provide altered spacing of holes 30. The advantage of the resilient nature of memory band 14 is that it holds its form to allow for easy latching and to clear the tree as system 10 is being raised or lowered along the trunk of the tree.

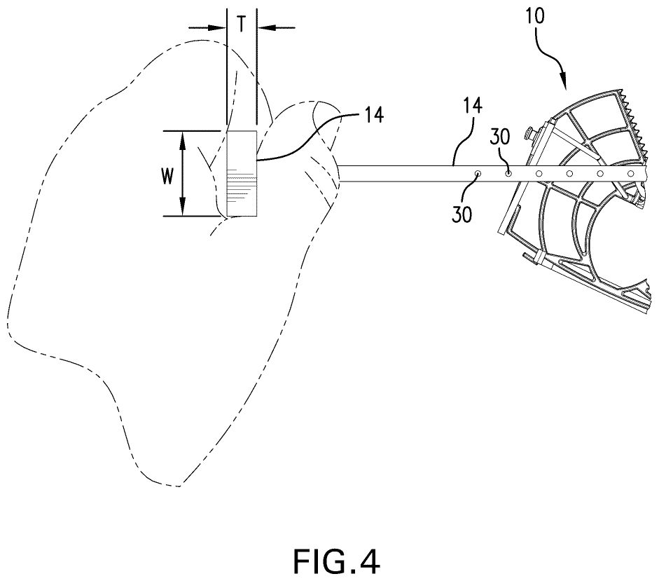

Now, additionally referring to FIG. 4, band 14 is shown in cross-section having a thickness T and a width W. Thickness T may be ¼ of an inch and width W may be ¾ inch. The approximate three to one ratio of width W to thickness T has been discovered to help provide optimal memory, compactness and strength for band 14.

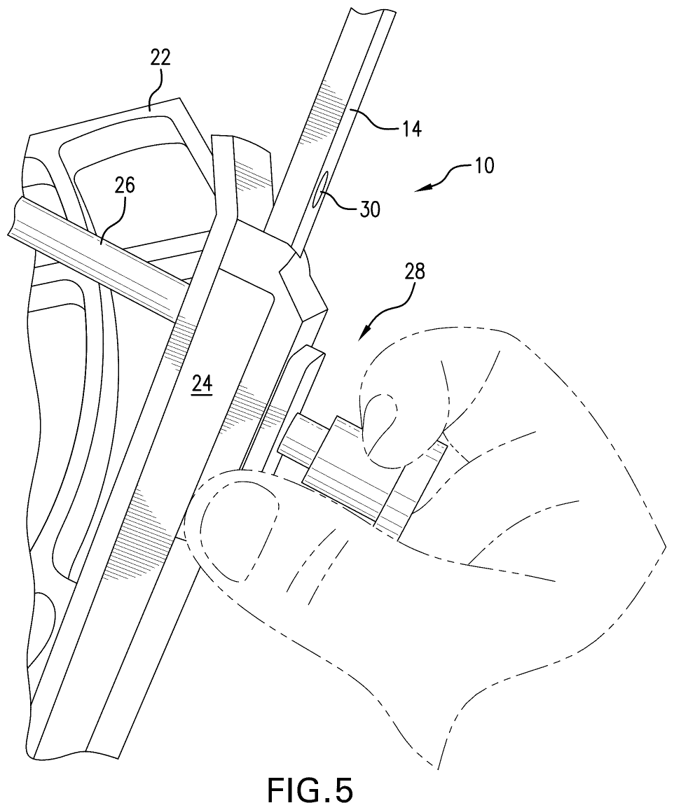

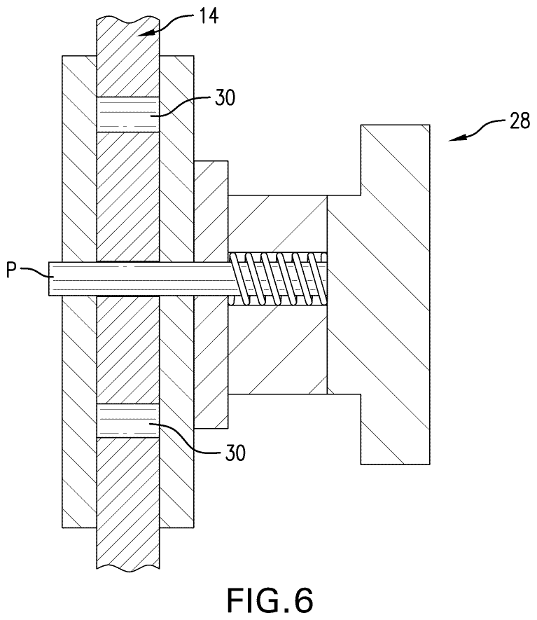

Now, additionally referring to FIG. 5, latch 28 is illustrated showing that a pulling motion releases a pin (shown in FIG. 6) from a hole 30 allowing band 14 to be adjusted or removed from latch 28. Latch 28 is integral with angled sides 24 thereby establishing the desired angle of memory band 14 relative to platform 22.

Now, additionally referring to FIG. 6, there is illustrated some of the interior features of latch 28 with pin P shown going through one of the holes 30 in band 14. Other latching mechanisms are contemplated such as levers. It is also contemplated that band 14 can have surface features that would allow a latching mechanism to interface with the surface features to latch band 14 to the latch mechanism without the need for holes 30.

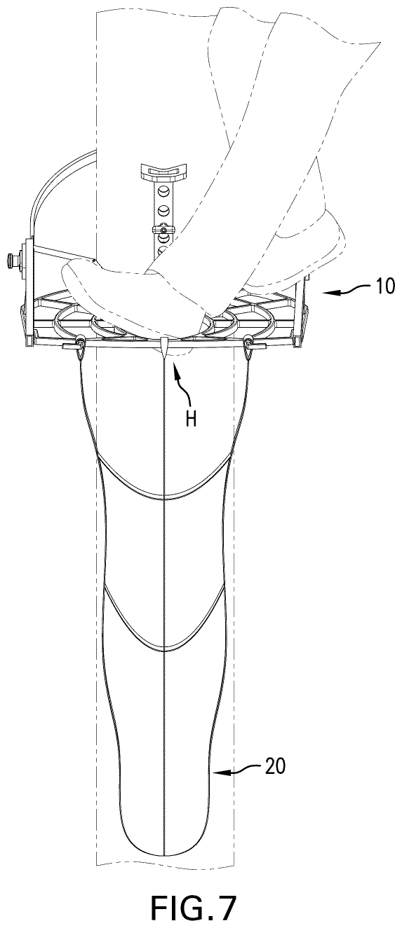

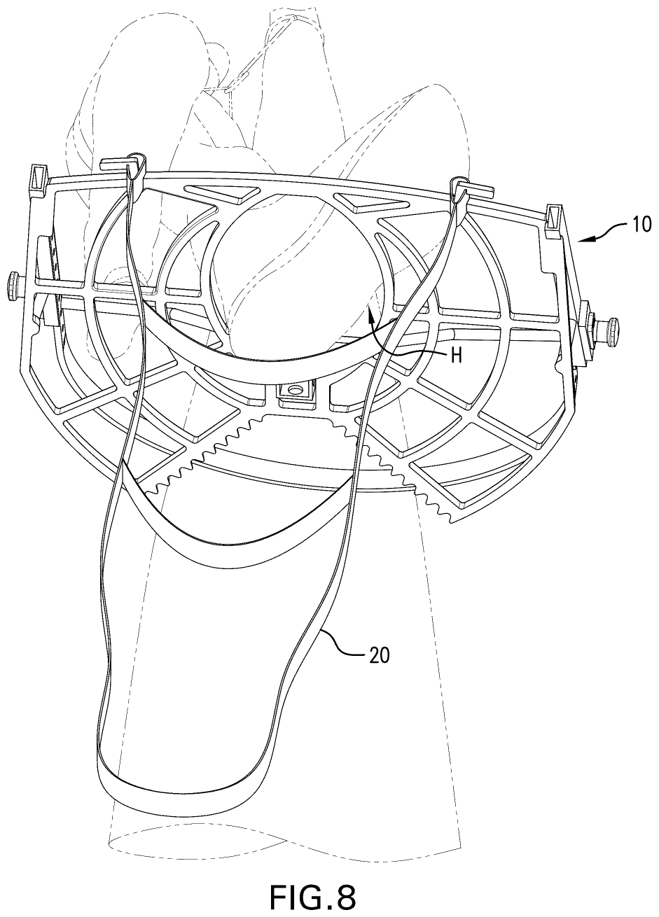

Now, additionally referring to FIGS. 7 and 8, the use of heal hole H can be seen from an upper perspective and a lower perspective. As can be seen the heal of a boot or shoe fits from any angle into heal hole H. Heal hole H is quasi-circular or has a D-shape with the flat portion being horizontally arranged perpendicular relative to a longitudinal extent of the tree.

Advantageously, as the hunter/operator is sitting in a sling or swing, he/she can be positioned against the tree and securely establish the position by having their heal in heal hole H. This provides for better and more stable positioning while their hands are free to use their weapon or camera. This results in more accuracy and a better hunting experience. This avoids losing a desired positioning as the tread of the platform and their shoe is inadequate to prevent them from sliding, particularly, since the swing/sling allows positioning of the legs of the hunter at angles that are significantly removed from being vertical. Heal hole H being sized and shaped so that at least a part of the heal of the hunter's footwear can extend through a bottom plane of platform 22.

Although, the terms ‘operator’ and ‘hunter’ are used herein, they are meant to refer to whoever is operating and using system 10, and can include anyone who is using system 10, whether system 10 is ultimately used for hunting, for observing or any other purpose.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A hunting platform system, comprising:
a platform couplable to a tree; and
a band extending around the tree and connected to both sides of the platform;
wherein the platform has a heal hole positioned in the platform to accommodate a heal of a hunter's footwear.

2. The hunting platform system of claim 1, further comprising at least one foot loop coupled to the platform, the at least one foot loop being used by the hunter to lift or lower the system on the tree.

3. The hunting platform system of claim 2, wherein the at least one foot loop is rigid.

4. The hunting platform system of claim 3, wherein the at least one foot loop is two foot loops.

5. The hunting platform system of claim 1, wherein the band is a memory band having a resilient memory.

6. The hunting platform system of claim 5, further comprising at least one band latch, the memory band having a series of holes therethrough, the band latch having a pin extending through a selected hole of the series of holes.

7. The hunting platform system of claim 5, wherein the band has a thickness and a width, the width being approximately 3 times larger than the thickness.

8. The hunting platform system of claim 1, further comprising a web ladder coupled to an edge of the platform.

9. A hunting platform system, comprising:
a platform couplable to a tree;
a band extending around the tree and connected to both sides of the platform; and
at least one foot loop coupled to the platform, the at least one foot loop being used by the hunter to lift or lower the system on the tree.

10. The hunting platform system of claim 9, wherein the at least one foot loop is rigid.

11. The hunting platform system of claim 10, wherein the at least one foot loop is two foot loops.

12. The hunting platform system of claim 9, wherein the platform has a heal hole positioned in the platform to accommodate a heal of a hunter being inserted therein, the heal hole being D-shaped.

13. The hunting platform system of claim 9, wherein the band is a memory band having a resilient memory.

14. The hunting platform system of claim 13, further comprising at least one band latch, the memory band having a series of holes therethrough, the band latch having a pin extending through a selected hole of the series of holes in the memory band.

15. The hunting platform system of claim 13, wherein the memory band has a thickness and a width, the width being approximately 3 times larger than the thickness.

16. The hunting platform system of claim 9, further comprising a web ladder coupled to an edge of the platform.

17. A method of positioning a hunting platform system, the method comprising the steps of a hunter:
positioning a hunting platform against a tree;
connecting a band to two sides of the platform, the band extending around a side of the tree;
climbing upon the hunting platform;
inserting the hunter's feet into at least one foot loop;
lifting the hunting platform with the hunter's feet while the hunter is otherwise supported;
engaging the tree with the platform at a new position; and
repeating the lifting and engaging steps until the platform is at a desired height.

18. The method of using the hunting platform system of claim 17, further comprising the step of while otherwise supported inserting the hunter's heal into a heal hole on the platform and swinging to a desired hunting position.

19. The hunting platform system of claim 17, wherein the band is a memory band having a series of holes therethrough.

20. The hunting platform system of claim 17, wherein the at least one foot loop is two foot loops that are rigid.
